(19) United States
(12) Patent Application Publication
(10) Pub. No.: US 2026/0066399 A1
(43) Pub. Date: Mar. 5, 2026

(54) SECONDARY BATTERY AND METHOD OF MANUFACTURING THE SAME

(71) Applicant: Samsung SDI Co., Ltd., Yongin-si (KR)

(72) Inventor: JAEIL SEONG, Yongin-si (KR)

(21) Appl. No.: 19/079,623

(22) Filed: Mar. 14, 2025

(30) Foreign Application Priority Data
Sep. 2, 2024 (KR) 10-2024-0118858

(51) Int. Cl. H01M 50/103; B21D 28/10; H01M 10/0525; H01M 10/0585; H01M 10/0587; H01M 50/15

(52) U.S. Cl. CPC H01M 50/103; B21D 28/10; H01M 10/0525; H01M 10/0585; H01M 10/0587; H01M 50/15

(57) ABSTRACT

A secondary battery includes a case with an inner space, the case including an opening in an upper end portion thereof and an interference prevention portion at a lower corner thereof, an electrode assembly inside the case, the interference prevention portion being configured to prevent interference between the case and a lower end corner portion of the electrode assembly, and a cap assembly electrically connected to the electrode assembly and coupled to the upper end portion of the case.

### CROSS-REFERENCE TO RELATED APPLICATION

This application claims priority to and the benefit of Korean Patent Application No. 10-2024-0118858, filed on Sep. 2, 2024, the disclosure of which is incorporated herein by reference in its entirety.

### BACKGROUND

### 1. Field

The present disclosure relates to a secondary battery having a structure in which a case does not interfere with an electrode assembly and a method of manufacturing the same.

### 2. Description of Related Art

Secondary batteries are batteries that can be (re)charged and discharged, unlike primary batteries that cannot be recharged. Low-capacity batteries may be used in portable small electronic devices such as smart phones, feature phones notebook computers, digital cameras, and camcorders, and high-capacity batteries may be used as motor driving power sources for hybrid vehicles, electric vehicles, and the like, power storage batteries, and the like.

A secondary battery may include an electrode assembly including positive and negative electrode plates, a case accommodating the electrode assembly, electrode terminals connected to the electrode assembly, a vent for degassing gas generated in the case, and the like. In addition, the electrode assembly may have a stacked structure of the positive and negative electrode plates with a separator therebetween, and the electrode assembly may output electrical energy while built into the case.

The above information disclosed in this Background section is for enhancement of understanding of the background of the present disclosure, and therefore, it may contain information that does not constitute a related (or prior) art.

### SUMMARY

In accordance with aspects of the present disclosure, there is provided a secondary battery including a case which provides an inner space and opens upward, an electrode assembly built into the case, and a cap assembly electrically connected to the electrode assembly and coupled to an upper end portion of the case, wherein the case is provided with an interference prevention portion, which prevents interference between the case and a lower end corner portion of the electrode assembly.

In accordance with other aspects of the present disclosure, there is provided a method of manufacturing a secondary battery case, which includes a primary molded article manufacturing operation of processing a sheet type material by deep drawing using a molding apparatus to manufacture a molded article including a bottom portion and sidewall portions, an extracting operation of extracting the molded article from a molding apparatus, and a groove forming operation of forming an interference prevention groove extending along a circumference of a bottom portion in a corner portion at which the bottom portion and the sidewall portions of the molded article meet.

In accordance with still another aspects of the present disclosure, there is provided a method of manufacturing a secondary battery case, which includes a punching operation of punching and processing a material with a predetermined thickness to obtain a punched article having a prospective bottom portion and prospective sidewall portions surrounding the prospective bottom portion, a groove forming process which is performed simultaneously with the punching operation and in which a notch groove is formed between the prospective bottom portion and the prospective sidewall portions, a folding operation of folding prospective sidewall portions upward, and a welding operation of welding open portions between the prospective sidewall portions to completely form a case including a bottom portion and sidewall portions after the folding operation is completed.

### BRIEF DESCRIPTION OF THE DRAWINGS

Features will become apparent to those of skill in the art by describing in detail exemplary embodiments with reference to the attached drawings, in which:

FIG. 1 is a cross-sectional view of a secondary battery according to an embodiment of the present disclosure;

FIG. 2 is a cross-sectional view of a secondary battery according to another embodiment of the present disclosure;

FIG. 3 is a schematic view for describing the principle of preventing interference between an electrode assembly and a case of a secondary battery according to embodiments of the present disclosure;

FIG. 4A to 4H are partial cross-sectional views illustrating various examples of a case in a secondary battery according to an embodiment of the present disclosure;

FIG. 5 is a partial cross-sectional view of another example of a secondary battery case according to an embodiment of the present disclosure;

FIG. 6 is a partial cross-sectional view of another example of a secondary battery case according to an embodiment of the present disclosure;

FIGS. 7A and 7B are cut perspective views illustrating corner inserts, each of which is applied to the case of FIG. 6;

FIGS. 8A to 8D are views for describing a method of manufacturing a secondary battery according to an embodiment of the present disclosure;

FIG. 9 is a view of a flowchart of the manufacturing method in FIGA. 8A-8D;

FIGS. 10A to 10D are views for describing a method of manufacturing a secondary battery according to another embodiment of the present disclosure;

FIG. 11 is a view of a flowchart of the manufacturing method in FIGS. 10A-10D;

FIGS. 12A to 12E are views for describing a method of manufacturing a secondary battery according to still another embodiment of the present disclosure;

FIG. 13 is a view of a flowchart of the manufacturing method in FIGS. 12A-12E;

FIGS. 14A to 14D are views for describing a method of manufacturing a secondary battery according to yet another embodiment of the present disclosure;

FIG. 15 is a view of a flowchart of the manufacturing method in FIGS. 14A-14D;

FIG. 16 is an exemplary view illustrating a secondary battery pack including a secondary battery according to an embodiment of the present disclosure; and

FIG. 17 is an exemplary view of a vehicle in which the secondary battery pack illustrated in FIG. 16 is installed.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

It will also be understood that if an element or layer is referred to as being “linked to,” “connected to,” or “coupled to” another element or layer, it may be directly linked, connected, or coupled to the other element or layer or one or more intervening elements or layers may also be present. When an element or layer is referred to as being “directly linked to,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same. ” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

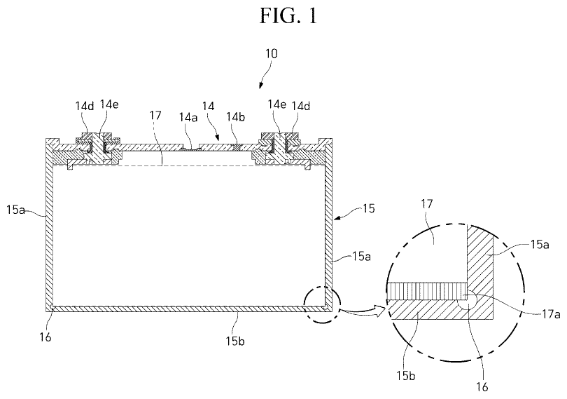

FIG. 1 is a schematic view illustrating a secondary battery 10 according to an embodiment of the present disclosure. The secondary battery 10 of FIG. 1 may be a prismatic secondary battery, and an electrode assembly 17 may be accommodated therein. As illustrated in FIG. 1, the secondary battery 10 according to the present embodiment may include a case 15 including an interference prevention portion, the electrode assembly 17, and a cap assembly 14.

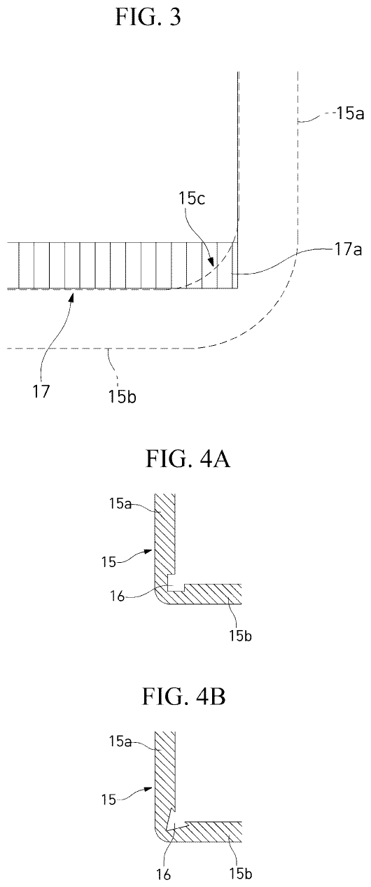

In detail, the case 15 may form an overall exterior of the prismatic battery and may be formed of a conductive metal such as aluminum, an aluminum alloy, or a steel coated with nickel. In addition, the case 15 may provide a space in which the electrode assembly 17 is accommodated. Particularly, the interference prevention portion is applied to the case 15. The interference prevention portion is a portion which serves to prevent interference of the case with a lower end corner portion 17a (see FIG. 3) of the electrode assembly and will be described below.

The cap assembly 14 may cover an opening of an upper end of the case 15. The cap assembly 14 may be electrically connected to the electrode assembly 17 in the case. A gas discharge hole 14a, an injection hole 14b, a terminal 14d, and a connecting member 14e may be provided in the cap assembly 14.

Two terminals 14d may be provided as a pair thereof, electrically connected to a positive electrode and a negative electrode of the electrode assembly 17, and exposed upward. In addition, the injection hole 14b may be a passage through which an electrolyte is injected, and the gas discharge hole 14a may be opened by gas generated in the secondary battery to perform a degassing operation.

For example, the electrode assembly 17 may be a jelly roll in which a first electrode plate, a separator, and a second electrode plate are wound. A winding axis of the jelly roll type electrode assembly may be disposed in a vertical direction. Since the electrode assembly 17 is disposed in the vertical direction, a bottom surface of the electrode assembly 17 may be supported by a bottom portion 15b of the case 15. In addition, a sidewall of the electrode assembly 17 may be in contact with a sidewall portion 15a of the case. In addition, the lower end corner portion of the electrode assembly 17, i.e., a portion corresponding to a corner portion, at which the bottom portion 15b and the sidewall portion 15a of the case 15 meet, forms a right angle.

In another example, the electrode assembly 17 may be a Z-stack electrode assembly in which the separator bent in a Z-stack is inserted into both sides of the first electrode plate and the second electrode plate. In addition, one or more electrode assemblies 17 may be stacked to be adjacent to each other and accommodated in the case. The first electrode plate of the electrode assembly 17 may serve as a negative electrode, the second electrode plate thereof may serve as a positive electrode, e.g., the reverse thereof is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab is formed by being cut in advance to protrude to one side of the electrode assembly, or the first electrode tab protrudes to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator prevents or substantially reduces instances of a short circuit between the first electrode plate and the second electrode plate while allowing movement of lithium ions therebetween. The separator may be made of, e.g., a polyethylene film, a polypropylene film, a polyethylene-polypropylene film, or the like.

In some embodiments, the electrode assembly 17 is accommodated in the case 15 along with an electrolyte.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel oxide, a lithium cobalt oxide, a lithium manganese oxide, a lithium iron phosphate compound, a cobalt-free nickel-manganese oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2);

LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode for the secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si negative electrode active material or a Sn negative electrode active material may be used as the material capable of being doped and undoped with lithium. The Si negative electrode active material may be silicon, a silicon-carbon composite, SiOₓ (0<x<2), a Si alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate, an ester, an ether, a ketone, an alcohol solvent, an aprotic solvent, and may be used alone or in combination of two or more.

In addition, when a carbonate solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

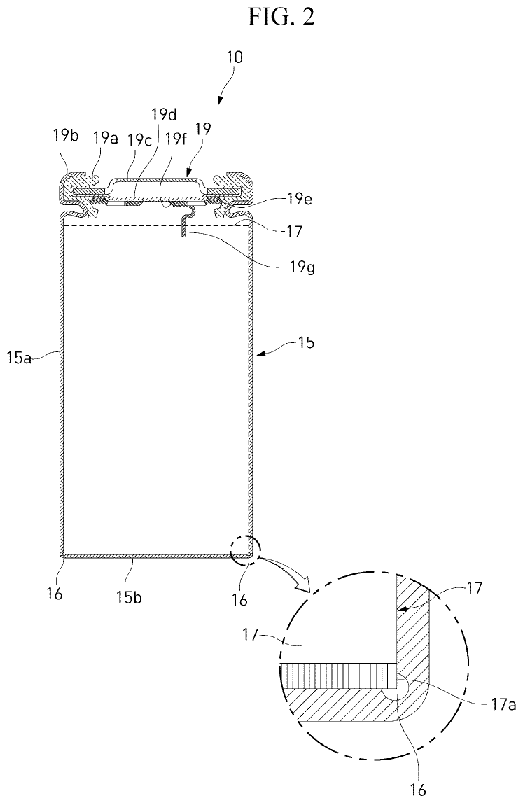

Meanwhile, the case 15 may provide an inner space and have a shape that opens upward. The cap assembly 14 may be mounted on an upper end portion of the case 15. The shape of the case 15 may vary depending on the type of secondary battery. For example, referring to FIG. 1, the secondary battery may have a prismatic shape, and the case 15 may have a quadrangular shape. In another example, referring to FIG. 2, the secondary battery may have a cylindrical shape, and the case may have a cylindrical shape.

FIG. 2 is a view illustrating a secondary battery according to another embodiment of the present disclosure. The secondary battery of FIG. 2 is a cylindrical secondary battery. The same reference numerals as the above-described reference numerals indicate the same components having the same functions.

Referring to FIG. 2, the secondary battery 10 illustrated in FIG. 2 may include the case 15 having an interference prevention portion, the electrode assembly 17, and a cap assembly 19.

The case 15 may have a cylindrical shape opened upward and accommodating the electrode assembly 17 and the electrolyte. The cap assembly 19 may be coupled to the opening of the case 15 to seal the case 15.

The bottom portion 15b of the case 15 may have a disc shape. The bottom portion 15b may support a lower surface of the electrode assembly 17 to support the electrode assembly 17. In addition, the sidewall portion 15a may be bent upward from the bottom portion 15b and in contact with an outer surface of the electrode assembly 17. For example, the case 15 may be formed of steel coated with nickel. The case 15 may accommodate the electrode assembly 17 and the electrolyte and may form an exterior of the battery with the cap assembly 19.

The cap assembly 19 may be fixed to the inside of a crimping part 19b by a gasket 19a to seal the case 15. The cap assembly 19 may include a cap up 19c, a safety vent 19d, a cap down 19e, an insulating member, and a sub plate 19f, and may be modified in various ways.

The cap up 19c may be positioned at the uppermost part of the cap assembly 19. The cap up 19c may include a terminal part that protrudes upwardly and is connected to an external circuit, and an outlet for discharging gas may be arranged around the terminal part.

The safety vent 19d may be located under the cap up 19c. The safety vent 19d may include a protrusion part that protrudes convexly downwardly and is connected to the sub plate 19f, and at least one notch may be formed in the safety vent 19d around the protrusion part.

If gas is generated due to overcharging or abnormal operation of the secondary battery, the protrusion part is deformed upwardly by the pressure and separates from the sub plate 19f while the safety vent 19d is cut (e.g., bursts or tears) along the notch. The cut safety vent 19d may prevent the secondary battery from exploding by allowing for the gas to be discharged to the outside.

The cap down 19e may be below the safety vent 19d. The cap down 19e may have a first opening for exposing the protrusion part of the safety vent 19d and a second opening for gas discharge. The insulating member may be positioned between the safety vent 19d and the cap down 19e to insulate the safety vent 19d and the cap down 19e.

The sub plate 19f may be under the cap down 19e. The sub plate 19f may be fixed to a lower surface of the cap down 19e to block the first opening of the cap down 19e, and the protrusion part of the safety vent 19d may be fixed to the sub plate 19f. A lead tab 19g, which is drawn out from the electrode assembly 17, may be fixed to the sub plate 19f. Accordingly, the cap up 19c, the safety vent 19d, the cap down 19e, and the sub plate 19f may be electrically connected to the electrodes of the electrode assembly 17.

The electrode assembly 17 may be a jelly roll type assembly and may include a separator, a first electrode, and a second electrode. The first and second electrodes and the separator may be accommodated in the case 15 in a wound state. A lower end corner of the outer surface of the electrode assembly 17 may have a right angle.

Meanwhile, an interference prevention portion may be formed in the case 15 of the cylindrical secondary battery illustrated in FIG. 2. The interference prevention portion may perform the same function as the interference prevention portion of the case of the prismatic secondary battery described previously with reference to FIG. 1. In the following description, the case of the prismatic secondary battery and the case of the cylindrical secondary battery will not be distinguished, and the description may be applied equally to both the prismatic secondary battery and the cylindrical secondary battery of FIG. 1 and FIG. 2, respectively.

The interference prevention portion may be formed in a corner portion 15c (FIG. 3) at which the bottom portion 15b and the sidewall portion 15a of the case 15 meet. The interference prevention portion may provide a space serving to prevent a lower end corner portion 17a of the electrode assembly 17 from being pressed by the corner portion of the case 15, as will be described in more detail below with reference to FIG. 3.

FIG. 3 is a schematic view for describing prevention of interference between the electrode assembly 17 and the case 15, according to embodiments of the present disclosure.

Referring to FIGS. 1-2, the bottom portion 15b of the case 15 may be a flat portion supporting the lower surface of the electrode assembly 17. In addition, the sidewall portion 15a may be a portion in contact with a side surface of the electrode assembly 17. The sidewall portion 15a may be bent to have an approximate right angle (e.g., to be substantially perpendicular) with respect to the bottom portion 15b.

However, referring to FIG. 3, since a continuous sheet type metal material may be bent to form both the sidewall portion 15a and the bottom portion 15b of the case 15 (e.g., so the sidewall portion 15a and the bottom portion 15b are integral with each other), the sidewall portion 15a may be bent with respect to the bottom portion 15b to have the corner portion 15c at a connection portion between the bottom portion 15b and the sidewall portion 15a.

As illustrated in FIG. 3, the corner portion 17a of the electrode assembly 17 having a right angle may be formed at a lower end of an outer side of the electrode assembly 17. If an inner surface of the corner portion 15c of the case 15 were to be bent and rounded without the interference prevention portion, when the electrode assembly 17 were to be inserted into the case 15, the corner portion 17a of the lower end of the electrode assembly 17 would have been pressed against and deformed by the corner portion 15c without the interference prevention portion. Such deformation of the corner of the electrode assembly 17 may be undesirable, and when a length of an electrode plate is formed to be short to prevent such a phenomenon, the charging and discharging capacity of the secondary battery may decrease.

In contrast, the interference prevention portion of the present embodiment may prevent deformation of the corner portion 17a by the corner portion 15c. As such, the corner portion 17a of the electrode assembly 17 may maintain the right angle of the lower end of the outer portion of the electrode assembly 17, and the length of the electrode plate may be maximized to increase power capacity.

The interference prevention portion of the present embodiment may be implemented as an interference prevention groove 16. The interference prevention groove 16 may be formed in the corner portion 15c at which the sidewall portion 15a and the bottom portion 15b meet (e.g., at an inner surface of the corner portion 15c), and may prevent or substantially minimize the corner portion 17a of the electrode assembly 17 from being pressed and deformed by the corner portion 15c of the case 15. For example, the interference prevention groove 16 may be a recess or a cavity into the inner surface of the corner portion 15c (e.g., so a thickness of a portion of the sidewall portion 15a and/or the bottom portion 15b in the corner portion 15c may be smaller than the thickness of portions of the sidewall portion 15a and the bottom portion 15b outside the corner portion 15c), such that an interior of the interference prevention groove 16 may be in fluid communication with the interior of the case 15.

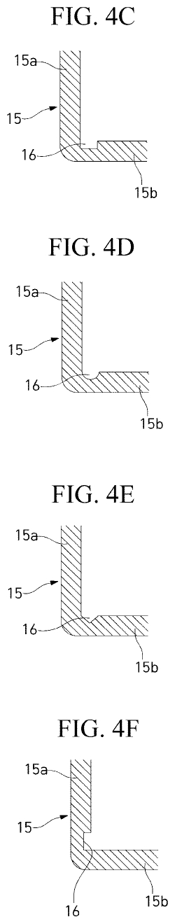

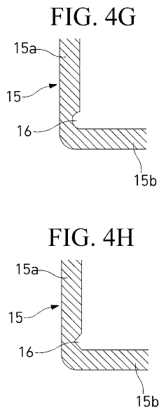

For example, referring to FIGS. 4F, 4G, and 4H, the interference prevention groove 16 in the corner portion 15c may be formed in only the sidewall portion 15a (i.e., not in the bottom portion 15b) of the case 15. In another example, referring to FIGS. 4C, 4D, and 4E, the interference prevention groove 16 in the corner portion 15c may be formed in only the bottom portion 15b (i.e., not in the sidewall portion) of the case 15. In still another example, referring to FIGS. 4A and 4B, the interference prevention groove 16 in the corner portion 15c may be formed in both the sidewall portion 15a and the bottom portion 15b of the case 15.

FIGS. 4A to 4H are partial cross-sectional views illustrating various examples of the case 15 in the secondary battery according to embodiments of the present disclosure. In addition, as illustrated in the drawings, the interference prevention groove 16 having any one of various shapes may be formed in the case 15.

An interference prevention groove 16 having a quadrangular cross-sectional shape may be formed in the case 15 illustrated in FIG. 4A. The interference prevention groove 16 may extend along a circumferential direction of the bottom portion 15b and may be open toward (e.g., in fluid communication with) an inner space of the case 15. The interference prevention groove of FIG. 4A may include portions of both the sidewall portion 15a and the bottom portion 15b, e.g., the interference prevention groove of FIG. 4A may be oriented diagonally with respect to the corner portion.

The interference prevention groove 16 illustrated in FIG. 4B may have a triangular cross-sectional shape and may be open toward the inner space of the case. The interference prevention groove 16 illustrated in FIG. 4B may include portions of both the sidewall portion 15a and the bottom portion 15b like the interference prevention groove of FIG. 4A, e.g., the interference prevention groove of FIG. 4B may be oriented diagonally with respect to the corner portion.

In addition, each interference prevention groove 16 of the case 15 illustrated in FIG. 4C to FIG. 4E may be formed in the corner portion, such that the interference prevention groove 16 is formed in an outer portion of only the bottom portion 15b, not in the sidewall portion 15a, and may have a shape vertically open upward. The interference prevention groove 16 of FIG. 4C has a right-angled bottom surface, and the interference prevention groove of FIG. 4D has a U-shaped bottom surface. In addition, the interference prevention groove of FIG. 4E has a V-shaped cross-sectional shape.

In addition, each interference prevention groove 16 of the case 15 of FIGS. 4F to 4H may be formed in the corner portion, such that the interference prevention groove 16 is formed in a lower end portion of the sidewall portion 15a without being formed in the bottom portion 15b. The interference prevention groove 16 of FIG. 4F has a right-angled bottom surface, the interference prevention groove 16 of FIG. 4G has a U-shaped cross-sectional shape. In addition, the interference prevention groove 16 of FIG. 4H has a V-shaped bottom surface.

The interference prevention groove 16 may have any suitable shape as long as the lower end corner portion 17a of the electrode assembly 17 is prevented from being pressed. In addition, processing of the interference prevention groove 16 may be implemented by a plastic processing method or a cut processing method.

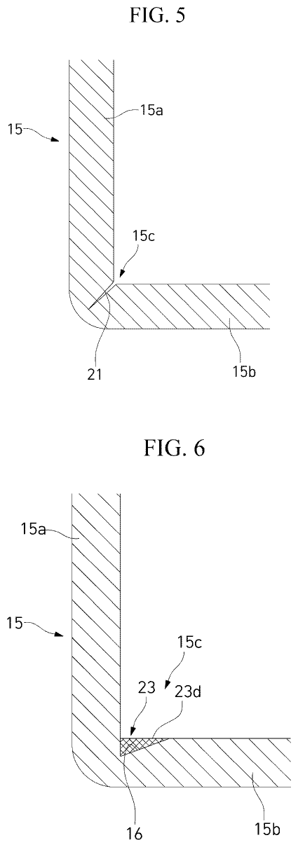

FIG. 5 is a partial cross-sectional view illustrating another example of a secondary battery according to an embodiment of the present disclosure.

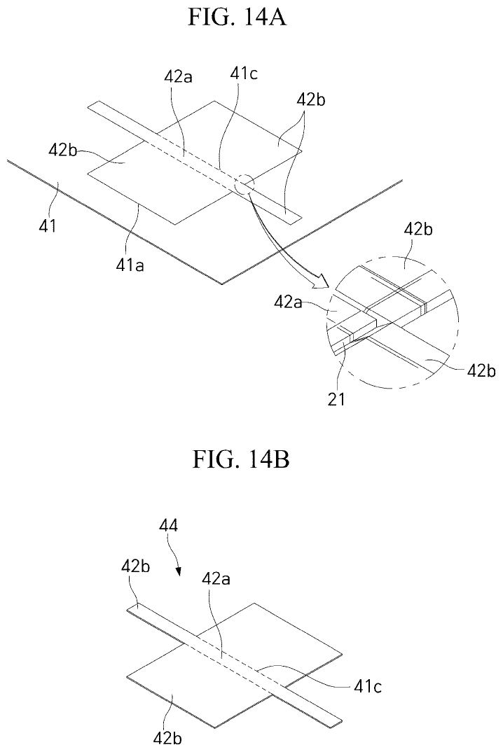

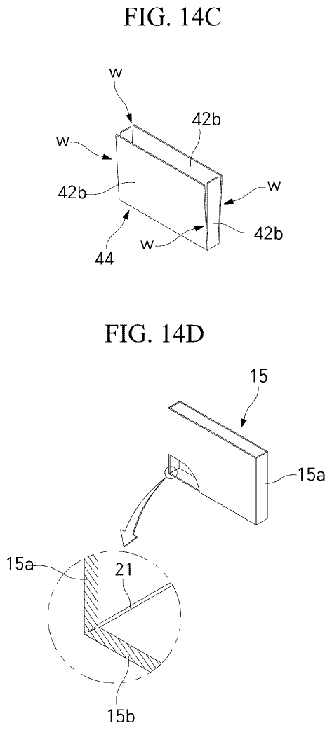

Referring to FIG. 5, a notch groove 21 may be applied as an interference prevention portion. The notch groove 21 is a portion in which a V-shaped notch groove 21 illustrated in FIG. 14A is folded. The interference prevention groove 16 may be formed, or the notch groove 21 may be applied, as the interference prevention portion depending on the method of manufacturing the case 15.

FIG. 6 is a partial cross-sectional view illustrating still another example of a secondary battery according to an embodiment of the present disclosure.

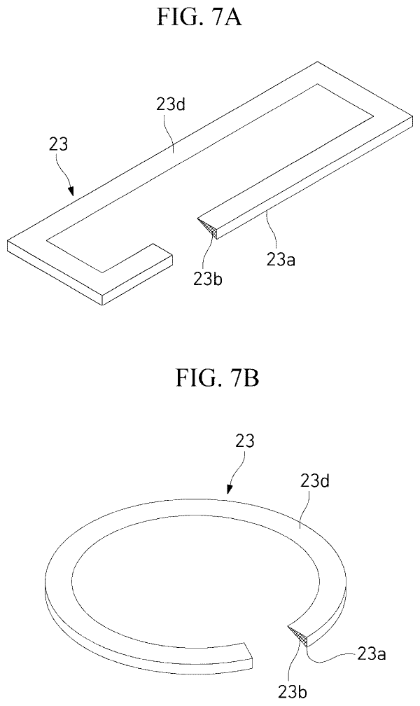

Referring to FIG. 6, the case 15 of the secondary battery illustrated in FIG. 6 may include a corner insert 23. The corner insert 23 may be a separate member fixedly inserted into an interference prevention groove 16, which is formed previously, and may have any of the shapes illustrated in FIGS. 7A and 7D.

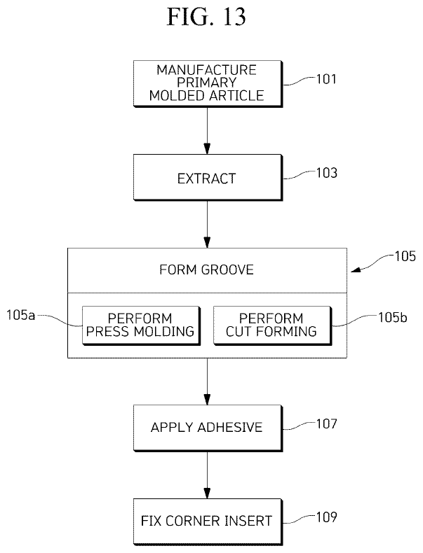

The corner insert 23 may serve to reinforce the strength of the case 15. As the interference prevention groove 16 is formed, the corner portion 15c of the case 15 may become thinner and structurally weaker, and thus, the corner insert 23 may be applied to reinforce the strength of the case 15. The corner insert 23 may be made of the same material as the case 15, and may be fixedly inserted into the case 15 through a corner insert fixing operation 109 of FIG. 13.

FIGS. 7A and 7B are cut perspective views illustrating the corner inserts 23, each of which is applied to the case of FIG. 6.

For example, referring to FIG. 7A, the corner insert 23 may have a rectangular shape. In another example, referring to FIG. 7B, the corner insert 23 may have a circular shape.

Referring to FIGS. 7A and 7B, a blade portion 23a may be formed in a lower end portion of the corner insert 23. When the corner insert 23 is lowered into the case 15, the blade portion 23a may slide on an inner surface of the sidewall portion 15a. When a fine protrusion is present on the inner surface of the sidewall portion 15a, the blade portion 23a cuts the protrusion. If there is no blade portion, when the corner insert 23 is lowered, the corner insert may be caught on the protrusion and may not descend, or may be deformed while passing over the protrusion.

In addition, a lower surface of the corner insert 23 may be an inclined surface portion 23b and in close contact with the interference prevention groove 16. The inclined surface portion 23b may be inclined upward in an inner direction of the corner insert 23 and may block the fine lateral movement of the corner insert 23.

In addition, an upper surface 23d of the corner insert 23 may be a flat horizontal surface and may be coplanar with an upper surface of a bottom portion 15b that face the interior of the case 15, as illustrated in FIG. 6. That is, the upper surface 23d does not form a step with respect to the upper surface of the bottom portion 15b.

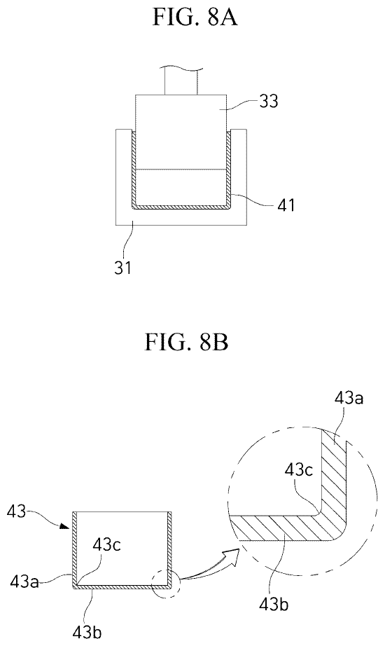

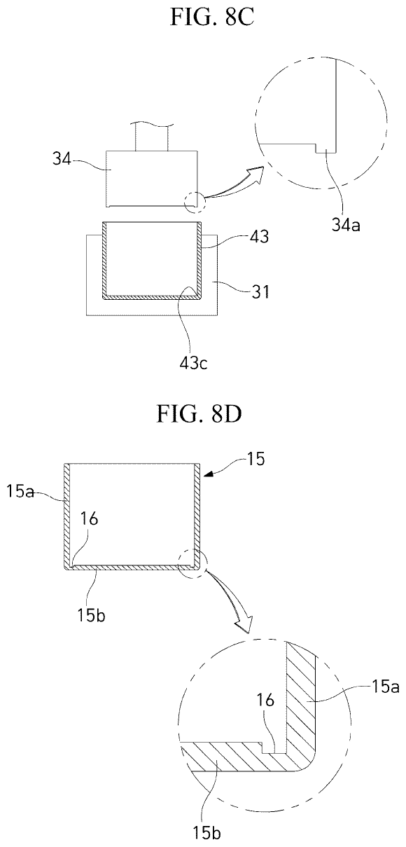

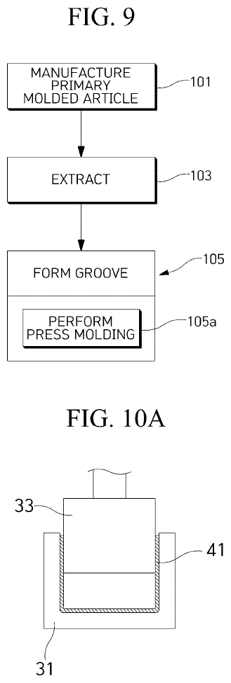

FIGS. 8A-8D are a set of views for describing a method of manufacturing a secondary battery according to an embodiment of the present disclosure, and FIG. 9 is a view illustrating a flowchart of the manufacturing method illustrated in FIGS. 8A-8D.

Referring to FIGS. 8A-8D and 9, the method of manufacturing a secondary battery according to the present embodiment may include a primary molded article manufacturing operation 101, an extracting operation 103, and a groove forming operation 105.

The primary molded article manufacturing operation 101 is an operation of manufacturing a primary molded article 43 by deep drawing a sheet type material 41 using a molding apparatus (see FIG. 8A). The molding apparatus may be a deep drawing apparatus including a die 31 and a punch 33. The punch 33 may be lowered into the die 31 with the material 41, e.g., so the punch 33 may push the material 41 toward the die 31 and shape the material 41 along and according to an inner surface of the die 31 to form the primary molded article 43.

The extracting operation 103 may be an operation of extracting the manufactured primary molded article 43 from the molding apparatus. That is, the extracting operation 103 is an operation of taking the primary molded article 43 out of the die 31. The extracted primary molded article 43 may be a case in a state in which an interference prevention groove 16 is not yet formed. The primary molded article 43 may have the same shape as the quadrangular case of a prismatic secondary battery or a cylindrical case of a cylindrical secondary battery.

A bottom portion 43b and a sidewall portion 43a may be included in the primary molded article 43. In addition, a corner portion 43c may be formed between the bottom portion 43b and the sidewall portion 43a. The corner portion 43c is a portion having a bent surface and is a removal target portion to be removed through the groove forming operation.

The subsequent groove forming operation 105 is an operation of forming the interference prevention groove 16 in the corner portion 43c of the primary molded article 43. That is, an interference prevention groove extending along a circumference of the bottom portion 43b is formed in the corner portion 43c.

The groove forming operation 105 may include a press molding process 105a. The press molding process 105a may be a process of mounting the primary molded article 43 in the die 31, moving a groove processing punch 34 downward toward the die 31 with the primary molded article 43, and plastically deforming a peripheral portion of the bottom portion 43b to form the interference prevention groove 16.

As illustrated in FIG. 8C, the groove processing punch 34 may have a groove forming protrusion 34a on an edge portion of a lower surface of the groove processing punch 34. The groove forming protrusion 34a may be a protrusion for plastically processing a bottom of the primary molded article 43. When the groove processing punch 34 is lowered and then raised, the interference prevention groove 16 may be formed.

After the groove forming operation 105 is completed, when the processed product is taken out of the die 31, the case 15 (see FIG. 8D) may be obtained. As illustrated in FIG. 8D, the interference prevention groove 16 is formed in an outer portion of the bottom portion 15b of the case 15. A shape of the interference prevention groove 16 may vary depending on the shape of the groove forming protrusion 34a of the groove processing punch 34. The case 15 may be input to a battery production line after undergoing a quality inspection.

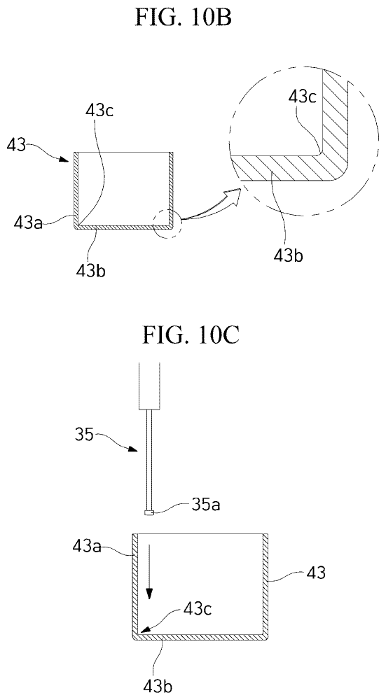

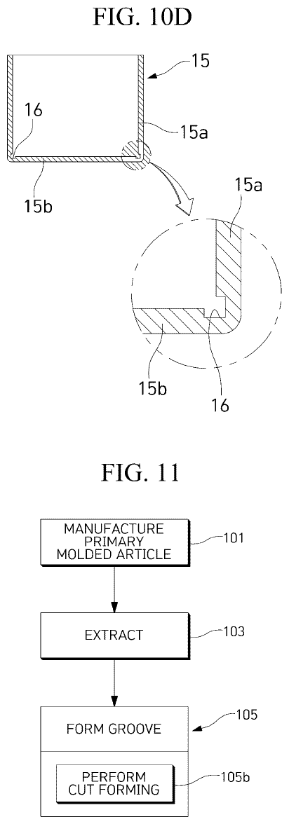

FIGS. 10A-10D is a set of views schematically showing a method of manufacturing a secondary battery according to another embodiment of the present disclosure, and FIG. 11 is a view illustrating a flowchart of the manufacturing method illustrated in FIGS. 10A-10D.

Referring to FIGS. 10A-10D and 11, a method of manufacturing a secondary battery may include the primary molded article manufacturing operation 101, the extracting operation 103, and the groove forming operation 105. The primary molded article manufacturing operation 101 and the extracting operation 103 are the same as those described with reference to FIGS. 8A-8B and 9.

The groove forming operation 105 of FIG. 10 may include a cut forming process 105b. The cut forming process 105b may be a process of forming the interference prevention groove 16 in the corner portion 43c of the primary molded article 43 by cutting. Although the interference prevention groove 16 in FIG. 8C is formed by a plastic processing method, the interference prevention groove 16 in FIG. 10C is formed by a cut processing method.

Since the interference prevention groove 16 is cut and processed as described above, the interference prevention groove 16 may be formed in a lower end portion of the sidewall portion 43a as well as the bottom portion 43b. That is, the interference prevention groove 16 may be formed in a peripheral portion of the bottom portion 43b, the lower end portion of the sidewall portion 43a, or both the peripheral portion of the bottom portion 43b and the lower end portion of the sidewall portion 43a.

A micro end mill 35 of FIG. 10C may be used to perform the cut forming process 105b. The micro end mill 35 may include a cutter 35a on a lower end portion of the micro end mill 35. A shape of the cutter 35a may vary. When the cutter 35a approaches the corner portion 43c while rotating, a bent portion of the corner portion 43c may be cut, and then the interference prevention groove 16 may be formed. A shape of the interference prevention groove 16 may vary depending on the type of the cutter 35a.

FIG. 10D shows an internal shape of the case 15 in which the interference prevention groove 16 is formed through the cut forming process 105b. As illustrated in the drawing, the interference prevention groove 16 is formed at a point at which the bottom portion 15b and the sidewall portion 15a meet.

A cut forming method may have an advantage of manufacturing the interference prevention groove 16 in any of various shapes, and particularly, have an additional advantage of manufacturing the interference prevention groove in the lower end portion of the sidewall portion 43a.

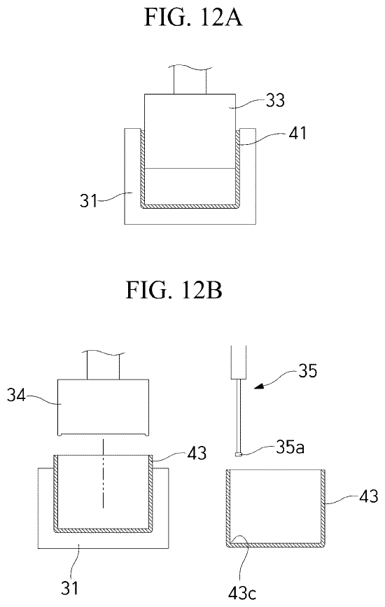

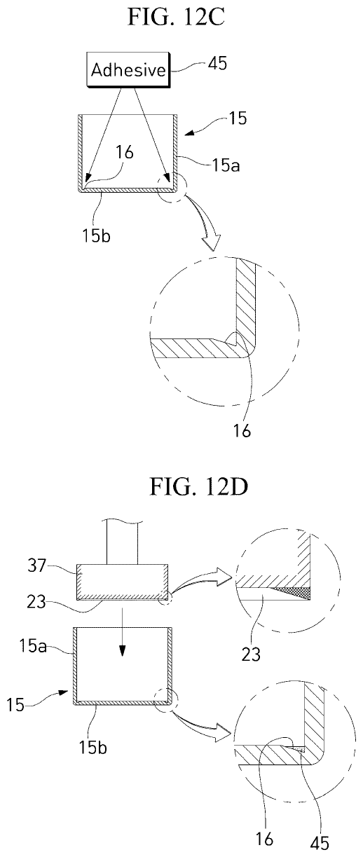

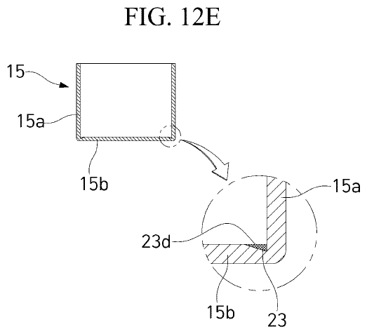

FIGS. 12A-12E are a set of views for describing a method of manufacturing a secondary battery according to still another embodiment of the present disclosure, and FIG. 13 is a view illustrating a flowchart of the manufacturing method illustrated in FIGS. 12A-12E.

The method of manufacturing a secondary battery illustrated in FIGS. 12A-12E and 13 may include the primary molded article manufacturing operation 101, the extracting operation 103, the groove forming operation 105, an adhesive application operation 107, and a corner insert fixing operation 109.

Referring to FIGS. 12A and 12B, the primary molded article manufacturing operation 101 may be a process of forming the primary molded article 43 from the material 41 through a deep drawing process, and the extracting operation 103 may be a process of taking the primary molded article 43 out of the die 31. The subsequent groove forming operation 105 may include the press molding process 105a or the cut forming process 105b. A worker may select one method from the press molding process 105a and the cut forming process 105b to form the interference prevention groove 16.

As illustrated in FIG. 12C, the adhesive application operation 107 may be a process of applying an adhesive 45 on the manufactured interference prevention groove 16. The adhesive 45 may maintain a state in which a corner insert 23 is firmly coupled to the interference prevention groove 16. The adhesive application operation 107 may be performed before the subsequent corner insert fixing operation is performed.

The corner insert fixing operation 109 is a process of press-fitting a separately prepared corner insert 23 into the preformed interference prevention groove 16. That is, as illustrated in FIG. 12D, the corner insert fixing operation 109 is a process of moving a lift head 37 downward in a state in which the corner insert 23 is fixed to a lower portion of the lift head 37 such that the corner insert 23 is inserted into the interference prevention groove 16. The corner insert 23 may be fixed by the adhesive while being inserted into the interference prevention groove 16. As described above, the corner insert 23 may reinforce the structural strength of a case 15. The case 15 illustrated in FIG. 12E is manufactured through the above-described process.

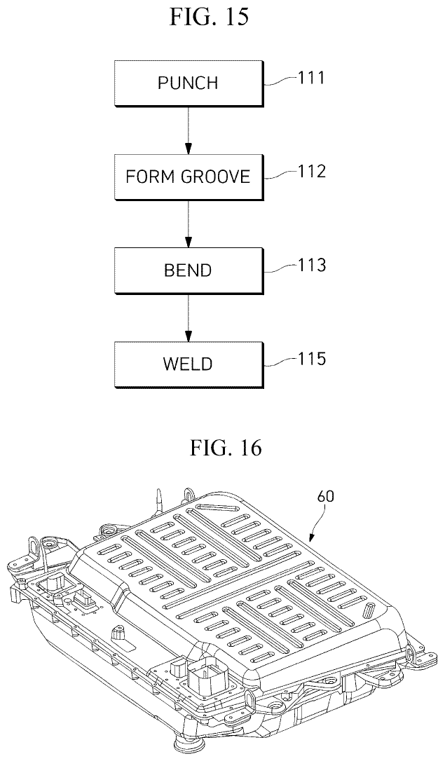

FIGS. 14A-14D is a set of views schematically showing a method of manufacturing a secondary battery according to yet other embodiment of the present disclosure, and FIG. 15 is a view illustrating a flowchart of the manufacturing method illustrated in FIGS. 14A-14D.

As illustrated in the drawings, the method of manufacturing a secondary battery according to the present embodiment may include a punching operation 111, a groove forming operation 112, a folding operation 113, and a welding operation 115. The method of manufacturing of FIGS. 14A-14D is a process of manufacturing the case 15 of a prismatic secondary battery. A case of a cylindrical secondary battery may also be manufactured through the same method.

The punching operation 111 may be a process of punching a material 41 with a predetermined thickness to cut out a punched article 44 (see FIG. 14B) from the material 41. The punching operation 111 may be a process of cutting along a cutting line 41a (see FIG. 14A) using a press mold.

The punched article 44 may include a prospective bottom portion 42a having a rectangular shape and four prospective sidewall portions 42b. The prospective bottom portion 42a is a portion which will become the bottom portion 15b of the case 15. In addition, the prospective sidewall portions 42b are portions which will become the sidewall portions 15a of the case 15.

A groove forming operation 111a and the punching operation 111 may be performed at the same time. The groove forming operation 111a is a process of forming a notch groove 21 between the prospective bottom portion 42a and a prospective sidewall portion 42b. The notch groove 21 serves as the interference prevention portion described above. According to the embodiment, the interference prevention groove 16 described with reference to FIGS. 4A-4H may be formed instead of the V-shaped notch groove 21.

The folding operation 113 may be a process of folding the prospective sidewall portions 42b upward. That is, the prospective sidewall portions 42b surrounding the prospective bottom portion 42a are folded at a right angle. FIG. 14C shows four prospective sidewall portions 42b being folded upward. The prospective sidewall portions 42b that are folded upward may be slightly unfolded without having geometrical right angles.

The subsequent welding operation 115 may be a process of welding an open portion w to completely form the case 15 after the folding operation 113 is completed. That is, as illustrated in FIG. 14C, the welding operation 115 may be a process of welding side end portions of the adjacent prospective sidewall portions 42b to each other.

The manufacturing of the case 15 illustrated in FIG. 14D may be completed through the above-described process. As illustrated in the drawings, the notch groove 21 is formed between the bottom portion 15b and the sidewall portion 15a of the case 15. The notch groove 21 may serve as an interference prevention portion which prevents a corner portion of an electrode assembly from being pressed.

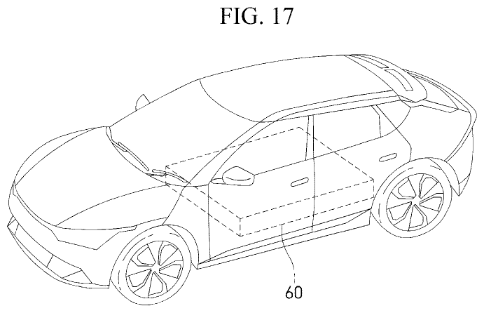

FIG. 16 is an exemplary view illustrating a secondary battery pack 60 including a secondary battery according to embodiments of the present disclosure. The secondary battery pack may be manufactured by a plurality of secondary battery modules being installed in a pack housing having a shape designed to be mounted in an actual product. The pack housing may include a fastening part and an electricity outlet part needed to be mounted in the product.

The battery pack 60 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle. FIG. 17 shows a vehicle that includes the battery pack 60 shown in FIG. 16 on the lower body thereof. The vehicle may operate by (e.g., may be powered by) receiving power from the battery pack 60.

By way of summation and review, a lower end portion of an outer surface of an electrode assembly may have a right angle, and a corner portion of a case corresponding to the outer end portion of the electrode assembly may be formed to be rounded, thereby interfering with the electrode assembly. In other words, a point, at which sidewall portions and a bottom portion of the case meet, may be rounded, and the electrode assembly in the case may be pressed or folded by the rounded portion, thereby requiring an additional free space for the separator. In addition, a length of the electrode plate may be decreased due to the above, thereby decreasing battery capacity.

In contrast, the present disclosure is directed toward a secondary battery, in which a corner portion of a case accommodating an electrode assembly does not come into contact or interfere with the electrode assembly so that the capacity of the electrode assembly increases and operational safety is improved, and a method of manufacturing the same. That is, in a secondary battery and a method of manufacturing the same of the present disclosure, a corner portion of a case in which an electrode assembly is accommodated includes an interference prevention groove that accommodates the corner of the electrode assembly and prevents contact (or interference) between the case and the electrode assembly, so that the capacity of the electrode assembly increases and operational safety is improved.

Aspects and features of the present disclosure are not limited to those described above, and other aspects and features not specifically mentioned herein will be clearly understood by those skilled in the art from the description of the present disclosure above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a case with an inner space, the case including an opening in an upper end portion thereof and an interference prevention portion at a lower corner thereof;
an electrode assembly inside the case, the interference prevention portion being configured to prevent interference between the case and a lower end corner portion of the electrode assembly; and
a cap assembly electrically connected to the electrode assembly and coupled to the upper end portion of the case.

2. The secondary battery as claimed in claim 1, wherein:
the case includes a bottom portion which supports the electrode assembly and sidewall portions which are integral with the bottom portion, the sidewall portions being bent upward from the bottom portion; and
the interference prevention portion includes an interference prevention groove in a corner portion of the case, at which the bottom portion and the sidewall portions meet, the interference prevention portion being configured to prevents the lower end corner portion of the electrode assembly from being pressed by the corner portion of the case.

3. The secondary battery as claimed in claim 2, wherein, in the corner portion, the interference prevention groove is in the bottom portion of the case and extending along a circumference of the bottom portion of the case.

4. The secondary battery as claimed in claim 2, wherein, in the corner portion, the interference prevention groove is in a lower end portion of the sidewall portion.

5. The secondary battery as claimed in claim 2, wherein the interference prevention groove is in a peripheral portion of the bottom portion and a lower end portion of the sidewall portion of the case.

6. The secondary battery as claimed in claim 2, wherein the interference prevention groove has a folded notch groove shape.

7. The secondary battery as claimed in claim 6, further comprising a corner insert in the interference prevention groove, the corner insert being configured to reinforce strength of the case.

8. The secondary battery as claimed in claim 7, wherein an upper surface of the corner insert is coplanar with the bottom portion of the case.

9. The secondary battery as claimed in claim 1, wherein the electrode assembly includes a wound type electrode assembly.

10. The secondary battery as claimed in claim 1, wherein the electrode assembly includes a stacked type electrode assembly.

11. A method of manufacturing a secondary battery case, the method comprising:
processing a sheet type material in a molding apparatus to manufacture a molded article including a bottom portion and sidewall portions;
extracting the molded article from the molding apparatus; and
forming an interference prevention groove in the molded article, such that the interference prevention groove extends along a circumference of a bottom portion in a corner portion at which the bottom portion and the sidewall portions of the molded article meet.

12. The method as claimed in claim 11, wherein forming the interference prevention groove includes plastically deforming a peripheral portion of the bottom portion to form the interference prevention groove.

13. The method as claimed in claim 11, wherein forming the interference prevention groove includes cutting and processing the corner portion to form the interference prevention groove.

14. The method as claimed in claim 13, wherein cutting and processing the corner portion includes forming the interference prevention groove in at least one of a peripheral portion of the bottom portion, a lower end portion of the sidewall portion, the peripheral portion of the bottom portion, and the lower end portion of the sidewall portion.

15. The method as claimed in claim 11, further comprising inserting a corner insert into the interference prevention groove.

16. The method as claimed in claim 15, further comprising applying an adhesive in the interference prevention groove.

17. A method of manufacturing a secondary battery case, the method comprising:
punching and processing a material to obtain a punched article having a prospective bottom portion and prospective sidewall portions surrounding the prospective bottom portion;
forming a notch groove between the prospective bottom portion and the prospective sidewall portions;
folding the prospective sidewall portions upward; and
welding open portions between the prospective sidewall portions to completely form a case including a bottom portion and sidewall portions, after folding the prospective sidewall portions upward.

18. The method as claimed in claim 17, wherein:
the prospective bottom portion has a quadrangular shape;
the prospective sidewall portions are integrated with four sides of the prospective bottom portion; and
side end portions of adjacent prospective sidewall portions are welded to each other when welding the open portions.

19. The method as claimed in claim 17, wherein forming the notch groove is performed simultaneously with punching and processing the material.

20. The method as claimed in claim 17, wherein forming the notch groove is performed separately after punching and processing the material.
